(19) United States
(12) Patent Application Publication
(10) Pub. No.: US 2026/0039218 A1
(43) Pub. Date: Feb. 5, 2026

(54) POWER SOURCE DEVICE AND IMAGE FORMING APPARATUS

(71) Applicant: CANON KABUSHIKI KAISHA, Tokyo (JP)

(72) Inventor: HIDEAKI YAMAGUCHI, Shizuoka (JP)

(21) Appl. No.: 19/277,632

(22) Filed: Jul. 23, 2025

(30) Foreign Application Priority Data
Aug. 2, 2024 (JP) 2024-127848

(51) Int. Cl. H02M 7/04; G03G 15/00; H02M 1/44

(52) U.S. Cl. CPC H02M 7/04; G03G 15/5004; G03G 15/80; H02M 1/44

(57) ABSTRACT

A power source device includes an ACDC converter, a capacitor connected between a power source line of the power source device and a ground, and a coil connected to the power source line between an AC power source and the ACDC converter. A switch is connected to the coil in parallel and short-circuits both ends of the coil by being turned on. A controller controls the switch to turn on or off and controls the switch to turn off in a case in which the electric power is a predetermined electric power or more, and controls the switch to turn on in a case in which the electric power is less than the predetermined electric power.

### BACKGROUND

### Field of Technology

The present invention relates to a power source device and an image forming apparatus such as an image forming apparatus provided with a power source including Y capacitor and a coil improving a power factor.

### Description of the Related Art

Conventionally, a power source device installed in an image forming apparatus such as a copy machine or a printer mostly has a Y capacitor connect to the power source line in order to deal with EMC (ELECTROMAGNETIC COMPATIBILITY). Some capacitors, such as a ceramic capacitor, include a feature (an electrostrictive effect) that expands and contracts by applying voltage and vibrate corresponding to a change of an applying voltage. A vibration of the ceramic capacitor itself or a vibration that a substrate installed with the ceramic capacitor vibrates on a frequency in a range from a few kHz to about 15 kHz is sometimes recognized as a sound in a audible band. This phenomenon is, hereinafter, referred to as ‘sounding’. A method reducing sounding, for example, that another ceramic capacitor which vibrates in an opposite phase is located in vicinity of the ceramic capacitor to cancel the vibration made in the substrate in order to reduce sounding is disclosed in Japanese Laid-Open Patent Application No. 2018-078137.

### SUMMARY

In conventional technology, because a ceramic capacitor with opposite phase and components of a peripheral circuit are needed corresponding to the number of capacitors, the size and cost of a substrate are increased. Also, it is difficult to reduce the sounding by resonance because the ceramic capacitor is not able to cancel the resonance with a coil which is located in vicinity of the ceramic capacitor.

The present invention is conceived under a situation described above and an object of this invention is reducing the vibration including a frequency in audible range generated in a power source device by a simple configuration.

In order to solve the problem described above, the present invention includes following configurations.
(1) A power source device for outputting an electric power, the power source device comprising: an ACDC converter configured to convert an AC voltage, supplied from an AC power source through a power source line, to a DC voltage; a capacitor connected between the power source line of the power source device and a ground; a coil connected to the power source line between the AC power source and the ACDC converter; a switch element connected to the coil in parallel and configured to short-circuit both ends of the coil by being turned on; and a control means configured to control the switch element to turn on or off, wherein the control means controls the switch element to turn off in a case in which the electric power outputted is a predetermined electric power or more, and controls the switch element to turn on in a case in which the electric power outputted is less than the predetermined electric power.
(2) An image forming apparatus provided with a power source device according

to claim 1, wherein the image forming apparatus is provided with an image forming means configured to form an image on a recording material, wherein the image forming apparatus is capable of operating in a first mode in which a print operation is performed and in a second mode in which an electric power consumed is lower than in the first mode, and wherein the control means controls the switch element to turn off in a case of performing in the first mode and controls the switch element to turn on in a case of performing in the second mode.

Further features of the present invention will become apparent from the following description of exemplary embodiments with reference to the attached drawings.

### BRIEF DESCRIPTION OF THE DRAWINGS

FIG. 1 is a schematic diagram showing a structure of an image forming apparatus in embodiments 1 and 2.

FIG. 2 is a schematic diagram of configuration of a power source device in the embodiment 1.

FIG. 3 is a flow chart showing on/off control of a switching element in the embodiment 1.

FIG. 4 is a graph showing a noise level in the embodiments 1 and 2.

FIG. 5 is a schematic view of configuration of a power source device in the embodiment 2.

FIG. 6 is a flow chart showing on/off control of the switching element in the embodiment 2.

FIG. 7 is a time chart showing on/off control of the switching element in the embodiment 2.

### DESCRIPTION OF THE EMBODIMENTS

### Embodiment 1

In the embodiment 1, a laser beam printer with an electrographic method is shown as an example of an image forming apparatus.

### Explanation of an Image Forming Apparatus

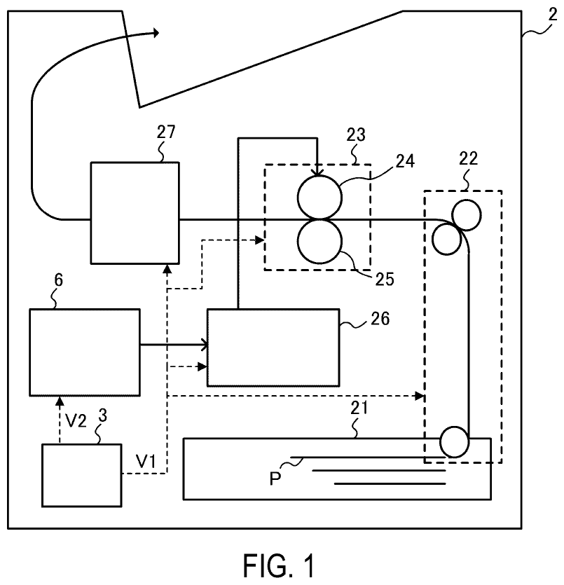

FIG. 1 is showing a schematic structure diagram of a laser beam printer 2 (hereinafter referred to as the printer 2) in the embodiment 1. A sheet P as a recording material stacked on a sheet feeding cassette 21 is conveyed to an image forming portion 23 by a sheet feeding/conveying portion 22. The image forming portion 23 as an image forming means is comprised of a charging portion, a developing portion, and a cleaning portion, those which are not shown, also comprised of a photosensitive drum 24 and a transfer portion 25. The surface of the photosensitive drum 24 is charged by the charging portion and an electrostatic latent image is formed on the photosensitive drum 24 by a laser output from an exposing portion 26. A toner image is formed on the photosensitive drum 24 by developing the electrostatic latent image with toner in the developing portion. Then, a toner image is formed on the photosensitive drum 24 by that the electrostatic latent image is developed with toner in the developing portion. The toner image is transferred onto a sheet P conveyed in a transfer portion 25. The toner image transferred onto the sheet P is fixed on the sheet P by heating and pressing in a fixing portion 27. Later, the sheet P is discharged from the apparatus of the printer 2. A series of controlling is executed by a main body control portion 6.

The main body control portion 6 includes a CPU (central processing unit), a ROM (read only memory), a RAM (random-access memory), and a timer, for example. The main body control portion 6 executes a program stored in the ROM in advance as using RAM as a temporary working area and controls the printer 2. When the main body control portion 6 controls the printer 2, the main body control portion 6 uses the timer to control all sorts of timing control. Note that, the main body control portion 6 may comprise of an ASIC (application specific integrated circuit) or a MPU (micro processing unit). A number of CPU, timer, ROM, or RAM is not limited to one, but can be plural. Also, other recording media, such as a hard disc or an optical disc may be used as a recording media. The printer 2 can transit to a standby state to start a next printing operation

quickly, when a predetermined time passed after a previous printing operation is completed. After a further predetermined time passed, the printer 2 transit to a sleep state which is a lower power consumption mode from the standby state to reduce power consumption on standby. The printer 2 is able to perform in 3 modes: in printing state as a first mode, and the standby state or the sleep state as a second mode of which power consumption is lower than the printing state. The main body control portion 6 configures the printer 2 to transit to each mode.

Also, the printer 2 is comprised of a power source device 3 supplying an electric power to each portion described above. As shown in FIG. 1 with a dotted line, the power source device 3 supplies: a voltage V1 described below to the portions such as the sheet feeding/conveying portion 22, the image forming portion 23, the exposing portion 26 and the fixing portion 27 (hereinafter, these portions are referred to as a main body driving portion 8) and, a voltage V2 described below to the main body control portion 6. In the printing state, the power source device 3 supplies: the voltage V1 to the main body driving portion 8, and the voltage V2 to the main body control portion 6. On the other hand, in the sleep state or the standby state, the power source device 3: cuts off supplying the voltage V1 to the main body driving portion 8, and supplies the voltage V2 to the main body control portion 6.

### Explanation of the Power Source Device

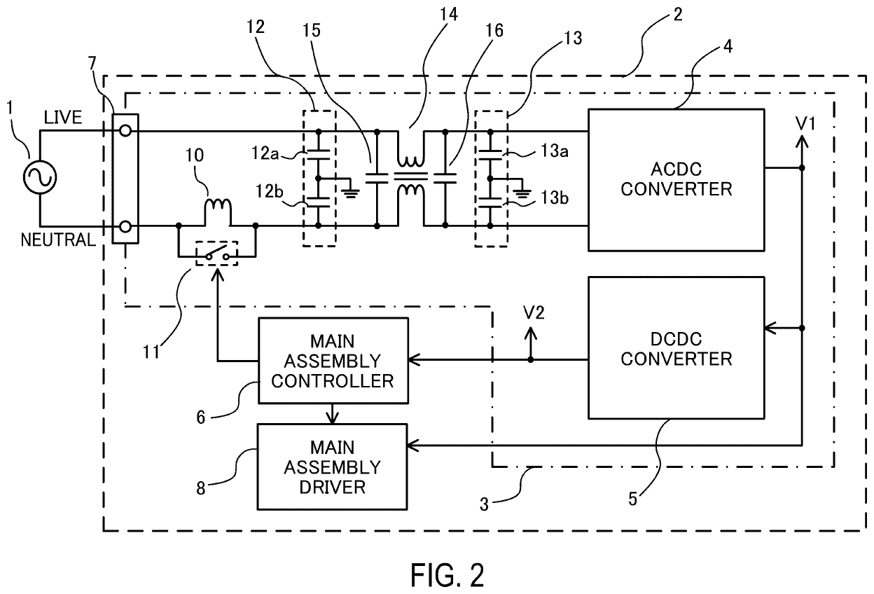

FIG. 2 is showing a schematic view of a structure of the power source device 3 in the embodiment 1. The power source device includes components and structures as follows. An inlet 7 is a connector to insert a power source cable. An AC power source 1 is supplied to the power source device 3 by inserting the cable connected to the AC power source 1. A coil 10 (a first coil) provided in a NEUTRAL line out of two power source lines between the inlet 7 and an ACDC convertor 4 is a coil for power factor improving in order to expand a conducting angle of an input current of the power source device 3. A switching element 11 is connected to the coil 10 in parallel, in other words, at both edges of an input and an output of the coil 10. The coil 10 is in a state of being short-circuited when the switching element 11 is turned on. As components for the switching element 11, for example, such as a triac or an electromagnetic relay are listed for use. To turn on or off the switching element 11 is controlled by the main body control portion 6 as a control means.

A capacitor 12a as a first capacitor and a capacitor 13a as a third capacitor which are disposed between a LIVE line and a ground are Y capacitors (bypass capacitors). Also, a capacitor 12b as a second capacitor and a capacitor 13b as a fourth capacitor which are disposed between the NEUTRAL line and the ground are the Y capacitors (the bypass capacitors). The capacitor 12a and the capacitor 12b are connected in series and the ground is connected between the capacitor 12a and the capacitor 12b. The capacitor 13a and the capacitor 13b are connected in series and the ground is connected between the capacitor 13a and the capacitor 13b.

The capacitor 12a and the capacitor 12b can be collectively called a capacitor 12 as a first capacitor group. The capacitor 13a and the capacitor 13b can be collectively called a capacitor 13 as a second capacitor group. The capacitor 12 and 13 are provided to reduce a common mode noise of the power source device 3. A common mode coil 14 (a coil, a second coil) is disposed between the capacitor 12 and the capacitor 13 and they are provided to reduce the common mode noise of the power source device 3. A capacitor 15 as a fifth capacitor and a capacitor 16 as a sixth capacitor disposed between the LIVE line and the NEUTRAL line are X capacitors (across the line capacitors) and they are provided to reduce a normal mode noise of the power source device 3. The capacitor 15 can be described as it is connected between the capacitor 12 and the common mode coil 14. The capacitor 16 can be described as it is connected between the capacitor 13 and the common mode coil 14.

An ACDC converter 4 rectifies an alternating current voltage of the AC power source 1 and generates the voltage V1 stepped-down to a predetermined voltage. The voltage 1 is a voltage: is used for an electric substrate or a motor which drives the main body driving portion 8, and is a direct current voltage with 24V, for example. As described above, the main body driving portion 8 is comprised of the sheet feeding/conveying portion 22, the image forming portion 23, the exposing portion 26, the fixing portion 27, and so on. The voltage V1 is input to a DCDC converter 5. The DCDC converter 5 makes the voltage V1 step-down and generates a voltage V2 used for the main body control portion 6 and so on. The voltage 2 is a direct current voltage of 3.3V, for example.

### Explanation of Controlling a Switching Element

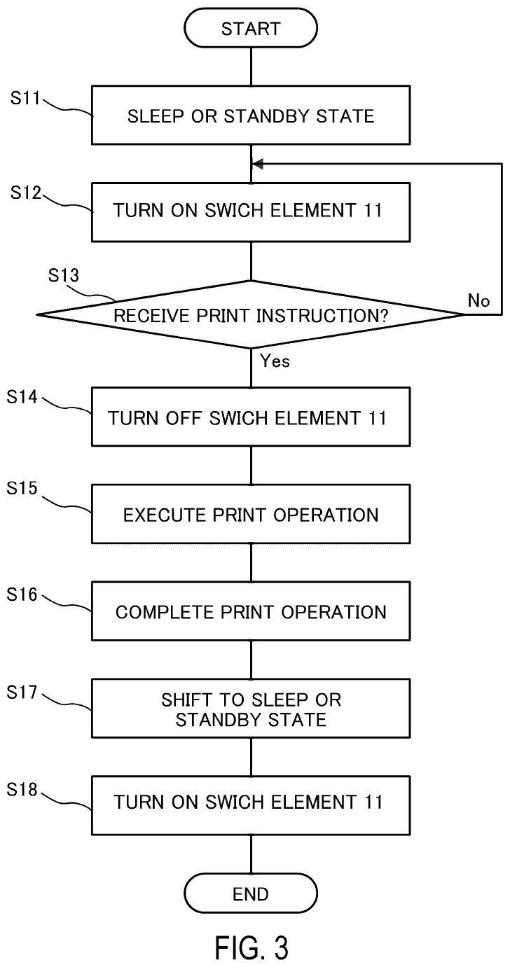

FIG. 3 is showing a flowchart related to a control method of a switching element 11 in the embodiment 1. The control method of the switching element will be described below along with the flowchart. In a step (hereinafter, referred to as S) 11, the printer 2 is in the sleep state waiting for a user's command or in the standby state when the AC power source 1 is applied to the inlet 7. The coil 10 installed in the power source device 3 resonates with the capacitor 12 and the capacitor 13, so that the sounding is generated by a vibration of a capacitor or a substrate as described above. Since a driving noise of the printer 2 itself is quieter in case that the printer 2 is in the sleep state or in the standby state, the user can hear the sounding louder relatively.

The main body control portion 6 controls the switching element 11 to be turned on when the printer 2 goes in the sleep state or in the standby state in order to suppress the sounding in S12. When the switching element 11 is turned on, the coil 10 goes in a short-circuited state and cuts off the vibration by resonating between the coil 10 and the capacitor 12/the capacitor 13. Therefore, the sounding is able to be suppressed.

### Results of Measuring Noise in the Sleep State

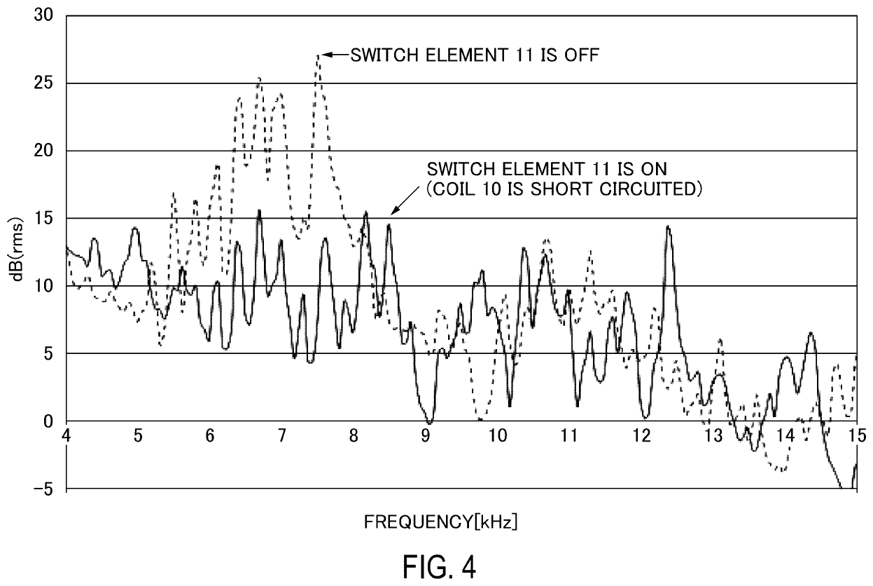

FIG. 4 is an example of results of measuring noise in the sleep state of the printer 2. The graph of FIG. 4 shows a comparison of the noise level before and after the coil 10 short-circuited. A vertical axis shows a noise level (dB) and a horizontal axis shows a frequency (kHz) in the graph. A dotted line shows a noise level during the switching element 11 is turned off and a solid line shows a noise level during the switching element is turned on (the coil 10 is short circuited).

When the switching element 11 is turned off, the noise of about 27 dB in maximum is generated between 5 kHz and 8 kHz of the frequency. On the other hand, when the switching element 11 is turned on (the coil 10 is short-circuited), the noise of about 16 kHz even in maximum in the same range of the frequency. It shows more than 10 dB is reduced, compared to the time while the switching element 11 is turned off. That is, the noise is quieter during the sleep state than the time when the main body driving portion 8 is working because the main body driving portion 8 is paused and supplying the voltage V1 to the main body driving portion 8 is cut off.

In a place where a user is in a quiet environment, the user may feel uncomfortable when the level of noise which has the frequency between a few kHz and about 15 kHz becomes more than 20 dB. The present invention makes it possible to reduce the noise level to less than 16 dB that the user does not feel uncomfortable by turning on the switching element 11. Note that, though an improving function of the power fact may be lost when the switching element 11 is turned on and the coil 10 is short-circuited, this function is not necessary since the printer 2 is in the low power consuming state such as the sleep state or the standby state. In other words, it is not a problem if the improving function of the power fact is obtained while the printer 2 is in the higher power consuming state such as the printing state.

Back to the explanation of the flowchart in FIG. 3. In S13, the main body control portion 6 determines whether a printing command is received from a user or not. In the case that the main body control portion determines the printing command is not received in S13, processing is returned to S12 and the switching element 11 is kept turning on. In the case that the main body control portion determines the printing command is received in S13, processing is sent to S14. In S14, the main body control portion 6 turns off the switching element 11 before starting the printing operation. In S15, the main body control portion 6 executes printing operation. As described above, the main body control portion 6 executes printing operation after turning off the switching element 11 and to enable the power fact improving function of the power source device 3.

In S16, the main body control portion 6 completes printing operation. In S17, the printer 2 is shifted to the sleep state or the standby state. In S18, the main body control portion 6 controls turning on the switching element 11 to let the coil 10 short circuited and completes a series of processing.

According to the embodiment 1, in the case that the printer 2 is in sleep state or standby state, the main body control portion 6 configures to turn on the switching element 11 to short-circuit the coil 10 so as to be able to eliminate resonance between the coil 10 and the capacitor 12/the capacitor 13 to suppress sounding. In the embodiment 1, the main body control portion 6 configures to turn on or off the switching element 11 corresponding to the state (mode) of the printer 2. In other words, the main body control portion 6 configures: to turn off the switching element 11 in the case that the electric power to be output is more than the predetermined value, and to turn on the switching element 11 in the case that electric power is less than the predetermined value.

Note that, the switching element 11 may have a structure including options that a user may select whether this function enables (is effective) or not. In more detail, the user may configure to enable or disable this function through keys on an operation panel provided in the printer 2. In other words, the printer 2 includes a configuring means and the configuring means may configure to set an effectiveness or ineffectiveness of an ON/OFF control of the switching element 11. Note that, the main body control portion 6 controls to turn on or off the switching element 11 when ‘enable (effectiveness)’ is configured. On the other hand, the main body control portion 6 does not control to turn on or off the switching element 11 and turns off the switching element 11 all the time and enables the power factor improving function of the coil 10 all the time when ‘disable (ineffectiveness)’ is configured.

As described above, according to the embodiment 1, the vibration including audible frequency generated in the power source device can be reduced by a simple structure.

### Embodiment 2

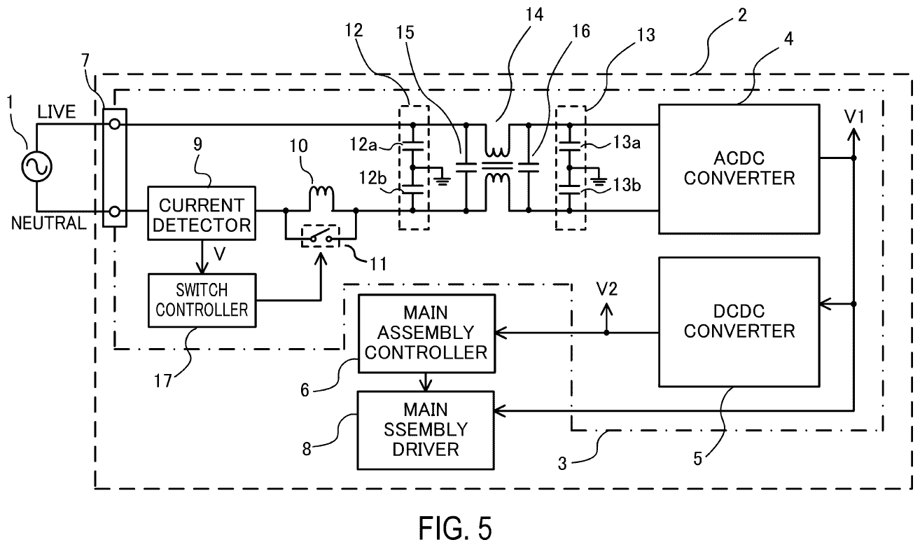

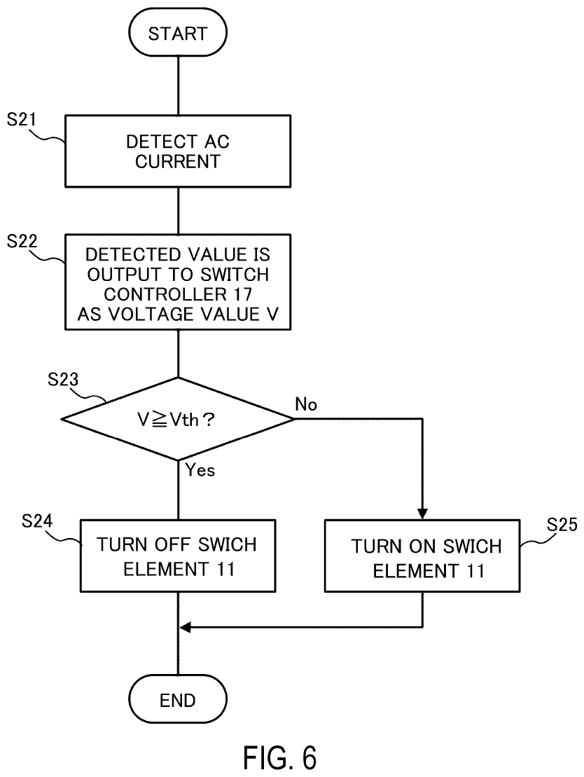

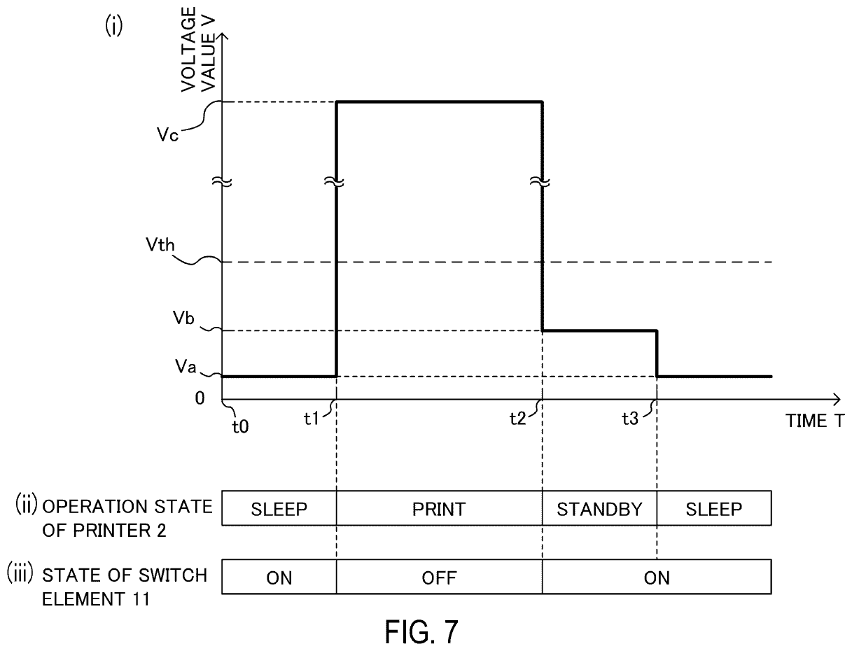

In an embodiment 2, different parts of the power source device will be mainly described with FIG. 5, FIG. 6, and FIG. 7. The main body control portion 6 turns on or off the switching element 11 corresponding to the state of the printer 2 in the embodiment 1. In the embodiment 2, the switching element 11 is turned on or off corresponding to a detected result of an electric current.

### Explanation of the Power Source Device

FIG. 5 shows a schematic view of a structure of a power source device 3 in the embodiment 2. Note that, the same number will be given on the same structure in FIG. 2, and the explanation will be omitted. A current detecting portion 9 as a detecting means detects a current supplied to the power source device 3 from the alternating power source 1 and outputs that detecting result to a switch control portion 17 as a control means. The current detecting portion 9 is comprised of electric components such as a current transformer and converts a secondary side current obtained in the current transformer into a voltage value V to output to the switch control portion 17. In the embodiment 2, controlling turning on or off the switching element 11 is executed by the switch control portion 17. The switch control portion 17 controls to: turn on the switching element 11 when the voltage value V is less than a predetermined value, and turn off the switching element 11 when the voltage value V is more than the predetermined value. In other words, the switch control portion 17 controls to turn on the switching element 11 (short-circuited the coil 10) when the detected value of the electric current is less than the predetermined value and turn off the switching element 11 when the detected value of the electric current is more than the predetermined value.

### Explanation of Switching Element

FIG. 6 shows a flow chart about a control method of the switching element 11 of the embodiment 2. The control method will be described along the flow chart below. In S21, the current detecting portion 9 detects a current value supplied to the power source device 3 from the alternating power source 1. Note that, the current value is always detected by the current detecting portion 9 during the printer 2 is operating without depending on an operating state of the printer 2. In S22, the current detecting portion 9 converts the detected result into the voltage value V and outputs the voltage value V to the switch control portion 17. In S23, the switch control portion 17: compares the voltage value V with a predetermined threshold value Vth, and determines whether the voltage value V is more than the threshold value Vth or not.

In the case that the switch control portion 17 determines that the voltage value V is more than the threshold value Vth in S23, the process is proceeded to S24. In S24, the switch control portion 17 configures to turn off the switching element 11 and completes the process. In the case that the switch control portion 17 determines that the voltage value V is less than the threshold value Vth in S23, the process is proceeded to S25. In S25, the switch control portion 17 configures to turn on the switching element 11 and completes the process. As described above, the coil 10 is short-circuited to be disabled when the current value supplied from the alternating power source 1 to the power source device 3 is less than the predetermined value and the coil 10 is functioned when the current value is more than the predetermined value in the embodiment 2.

### State of Switching Element

A control method of the switching element 11 will be described with FIG. 7. FIG. 7 is a time chart showing time variation about the voltage value V that the current detection portion 9 outputs, the operating state of the printer 2, and the state of the switching element 11. (i) shows time T in a horizontal axis, the voltage value V in a vertical axis, and the threshold value Vth with a dotted line. (ii) shows the operating state (sleep, print, or standby) of the printer 2. (iii) shows a state (on, off) of the switching element 11.

In a time range from a time t0 to a time t1, the printer 2 is in the sleep state and a voltage value Va is output to the switch control portion 17 from the current detecting portion 9. Since the voltage value Va is less than the threshold value Vth (Va<Vth), the switch control portion 17 configures to turn on the switching element 11. At the time t1, when a user commands to print to the printer 2, the printer 2 starts printing operation and keep printing operation until a time t2 at when printing is completed. In the time range from the time t1 and a time t2, the voltage value Vc is output to the switch control portion 17 from the current detecting portion 9. Since the voltage value Vc is more than the threshold value Vth (Vc≥Vth), the switch control portion 17 configures to turn off the switching element 11.

The printer 2 pauses printing operation and moves to the standby state at the time t2 and then keeps the standby state until a time t3 when the printer 2 moves in the sleep state. Between the time t2 and the time t3, a voltage value Vb is output to the switch control portion 17 from the current detecting portion 9. Since the voltage value Vb is less than the threshold value Vth (Vb<Vth), the switch control portion 17 configures to turn on the switching element 11. Note that, the voltage value Vb in the standby state is greater than the voltage value Va in the sleep state (Vb>Va).

The printer 2 moves to the time t3 in the sleep state. After the time t3, the voltage value Va is output to the switch control portion 17 from the current detecting portion 9. Since the voltage value Va is less than the threshold value Vth (Va<Vth), the switch control portion 17 configures to keep turning on the switching element 11.

As described above, according to the embodiment 2, it becomes possible to turn on the switching element 11 at the best timing to enable the coil 10 when the electric current value supplied to the power source device is increasing. Also, an interface between the main body control portion 6 and the power source device 3 can be simplified because the power source device 3 only itself can suppress sounding caused by the resonance between the coil 10 and the capacitors 12, 13 without the main body control portion 6 configuring. Note that, it is also possible to suppress sounding by a structure that a detecting result of the current detecting portion 9 is output to the main body control portion 6 and the main body control portion 6 configures to turn on or off the switching element 11 depending on the detected result by the current detecting portion 9 as well.

As describe above, according to the embodiment 2, the vibration including audible frequency generated in the power source device can be reduced by a simple structure.

### Other Embodiment

The present invention makes it possible to supply a program implementing a more advanced function than the embodiment 1 described above to a system or an apparatus through a network or a recording media, and to allow one or more processers in the computer of the system or the apparatus to read and execute the program. It is also possible to implement a more advanced function than the embodiment 1 by a circuit (i.e., ASIC) instead.

Disclosure of the present Embodiments includes the following constitutions.

### Constitution 1

A power source device for outputting an electric power, the power source device comprising:
an ACDC converter configured to convert an AC voltage, supplied from an AC power source through a power source line, to a DC voltage;
a capacitor connected between the power source line of the power source device and a ground;
a coil connected to the power source line between the AC power source and the ACDC converter;
a switch element connected to the coil in parallel and configured to short-circuit both ends of the coil by being turned on; and
a control means configured to control the switch element to turn on or off,
wherein the control means controls the switch element to turn off in a case in which the electric power outputted is a predetermined electric power or more, and controls the switch element to turn on in a case in which the electric power outputted is less than the predetermined electric power.

### Constitution 2

The power source device according to Constitution 1, wherein the capacitor is a ceramic capacitor.

### Constitution 3

The power source device according to claim 1, wherein the capacitor includes a first capacitor and a second capacitor connected to the first capacitor in series, and
wherein the ground is connected between the first capacitor and the second capacitor.

### Constitution 4

The power source device according to Constitution 3, wherein the capacitor further includes a third capacitor and a fourth capacitor connected to the third capacitor in series, and
wherein the ground is connected between the third capacitor and the fourth capacitor.

### Constitution 5

The power source device according to Constitution 4, wherein when the coil is a first coil, the first capacitor and the second capacitor are a first capacitor group, and the third capacitor and the fourth capacitor are a second capacitor group, a second coil connected between the first capacitor group and the second capacitor group is provided.

### Constitution 6

The power source device according to Constitution 5, further comprising a fifth capacitor connected between the first capacitor group and the second coil.

### Constitution 7

The power source device according to Constitution 6, further comprising a sixth capacitor connected between the second capacitor group and the second coil.

### Constitution 8

The power source device according to Constitution 7, wherein the first coil is connected between the first capacitor group and the AC power source.

### Constitution 9

The power source device according to any one of Constitution 1 to Constitution 8, further comprising a detecting means configured to detect a value of a current flowing through the power source line,
wherein the control means controls the switch element to turn off in a case in which the value of the current detected by the detecting means is a predetermined value or more, and controls the switch element to turn on in a case in which the value of the current detected by the detecting means is less than the predetermined value.

### Constitution 10

The power source device according to any one of Constitution 1 to Constitution 8, further comprising a setting means configured to set a control in which the control means controls the switch element to turn on or off to effectiveness or ineffectiveness,
wherein the control means controls the switch element to turn on or off in a case in which the effectiveness is set by the setting means, and controls the switch element to turn off in a case in which the ineffectiveness is set by the setting means.

### Constitution 11

An image forming apparatus provided with a power source device according to any one of Constitution 1 to Constitution 10, wherein the image forming apparatus is provided with an image forming means configured to form an image on a recording material,
wherein the image forming apparatus is capable of operating in a first mode in which a print operation is performed and in a second mode in which an electric power consumed is lower than in the first mode, and
wherein the control means controls the switch element to turn off in a case of performing in the first mode and controls the switch element to turn on in a case of performing in the second mode.

### Constitution 12

The image forming apparatus according to Constitution 11, wherein the control means controls to start the print operation after the switch element is to turn off in a case of transition from the second mode to the first mode, and controls the switching element to turn on after the print operation is completed in a case of transition from the first mode to the second mode.

According to the present invention, the vibration including audible frequency generated in the power source device can be reduced by a simple structure.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No.2024-127848 filed on Aug. 2, 2024, which is hereby incorporated by reference herein in its entirety.

What is claimed is:

1. A power source device for outputting an electric power, the power source device comprising:
an ACDC converter configured to convert an AC voltage, supplied from an AC power source through a power source line, to a DC voltage;
a capacitor connected between the power source line of the power source device and a ground;
a coil connected to the power source line between the AC power source and the ACDC converter;
a switch element connected to the coil in parallel and configured to short-circuit both ends of the coil by being turned on; and
a control means configured to control the switch element to turn on or off,
wherein the control means controls the switch element to turn off in a case in which the electric power outputted is a predetermined electric power or more, and controls the switch element to turn on in a case in which the electric power outputted is less than the predetermined electric power.

2. The power source device according to claim 1, wherein the capacitor is a ceramic capacitor.

3. The power source device according to claim 1, wherein the capacitor includes a first capacitor and a second capacitor connected to the first capacitor in series, and
wherein the ground is connected between the first capacitor and the second capacitor.

4. The power source device according to claim 3, wherein the capacitor further includes a third capacitor and a fourth capacitor connected to the third capacitor in series, and
wherein the ground is connected between the third capacitor and the fourth capacitor.

5. The power source device according to claim 4, wherein when the coil is a first coil, the first capacitor and the second capacitor are a first capacitor group, and the third capacitor and the fourth capacitor are a second capacitor group, a second coil connected between the first capacitor group and the second capacitor group is provided.

6. The power source device according to claim 5, wherein a fifth capacitor is connected between the first capacitor group and the second coil.

7. The power source device according to claim 6, wherein a sixth capacitor is connected between the second capacitor group and the second coil.

8. The power source device according to claim 7, wherein the first coil is connected between the first capacitor group and the AC power source.

9. The power source device according to claim 1, further comprising a detecting means configured to detect a value of a current flowing through the power source line,
wherein the control means controls the switch element to turn off in a case in which the value of the current detected by the detecting means is a predetermined value or more, and controls the switch element to turn on in a case in which the value of the current detected by the detecting means is less than the predetermined value.

10. The power source device according to claim 1, further comprising a setting means configured to set a control in which the control means controls the switch element to turn on or off to effectiveness or ineffectiveness,
wherein the control means controls the switch element to turn on or off in a case in which the effectiveness is set by the setting means, and controls the switch element to turn off in a case in which the ineffectiveness is set by the setting means.

11. An image forming apparatus provided with a power source device according to claim 1, wherein the image forming apparatus is provided with an image forming means configured to form an image on a recording material,
wherein the image forming apparatus is capable of operating in a first mode in which a print operation is performed and in a second mode in which an electric power consumed is lower than in the first mode, and
wherein the control means controls the switch element to turn off in a case of performing in the first mode and controls the switch element to turn on in a case of performing in the second mode.

12. The image forming apparatus according to claim 11, wherein the control means controls to start the print operation after the switch element is to turn off in a case of transition from the second mode to the first mode, and controls the switching element to turn on after the print operation is completed in a case of transition from the first mode to the second mode.
